(19) United States
(12) Patent Application Publication
(10) Pub. No.: US 2026/0339508 A1
(43) Pub. Date: Oct. 29, 2026

(54) COMPOSITION-AWARE STORAGE CLUSTERING WITH ADAPTIVE REDUNDANCY DOMAINS

(71) Applicant: Lenovo Enterprise Solutions (Singapore) Pte. Ltd., Singapore (SG)

(72) Inventors: Caihong Zhang, Shanghai (CN); Fred Allison Bower, III, Durham, NC (US); Lijun Gu, Shanghai (CN); Da Ke Xu, Shanghai (CN)

(21) Appl. No.: 19/116,959

(22) PCT Filed: Jul. 12, 2023
(86) PCT No.: PCT/CN2023/106930

§ 371 Date: Mar. 28, 2025

(51) Int. Cl. G06F 3/06

(52) U.S. Cl. CPC G06F 3/0604; G06F 3/0647; G06F 3/067

(57) ABSTRACT

A method for managing a storage cluster with a composable infrastructure includes receiving a file to be stored in the storage cluster. The storage cluster includes a plurality storage buckets, a plurality of computing nodes, and a plurality of targets mapped to the plurality of storage buckets though the plurality of computing nodes. The method further includes determining a mapping of the plurality of targets to the plurality of computing nodes; determining a mapping rule of each of the plurality of storage buckets to one of the plurality of targets by connecting through one or more of the plurality of computing nodes; generating and storing two or more copies of the file. Each copy of the file is stored in a storage bucket and a corresponding target. A copy of the file is split among the one or more computing nodes mapped to the storage bucket.

### TECHNICAL FIELD The present application relates to the field of computer science, and in particular, to composition-aware storage clustering with adaptive redundancy domains.

### BACKGROUND

Cloud platforms provide distributed storage by employing a cloud of networked storage devices and managing these storage devices through a distributed storage platform. The distributed storage platform empowers clients to store data in a distributed manner.

In a storage cluster that employs a composable infrastructure, computing nodes use shared storage resources for storing units of data and multiple replica copies of data are generated based on the data units stored at the computing nodes, thereby providing redundancy and reliability of data storage. The storage cluster assumes that each storage bucket for storing one of the replica copies is independent from another, and that having multiple replica copies of data would mean that the stored data file would be protected from a single node failure in the storage cluster. However, because in the composable infrastructure, common resources are assigned to multiple storage buckets and multiple nodes, the storage cluster is not aware of its composition. Thus, a malfunctioning in the composable infrastructure of the cloud platform, such as a failure in one of the shared storage resources, may cause the cloud platform to lose redundancy coverage and therefore cannot reconstruct the data.

### SUMMARY

In accordance with the disclosure, one aspect of the present disclosure provides a method for managing a storage cluster with a composable infrastructure. The method includes receiving a file to be stored in the storage cluster. The storage cluster includes a plurality storage buckets, a plurality of computing nodes, and a plurality of targets mapped to the plurality of storage buckets though the plurality of computing nodes. The method further includes determining a mapping of the plurality of targets to the plurality of computing nodes; determining a mapping rule of each of the plurality of storage buckets to one of the plurality of targets by connecting through one or more of the plurality of computing nodes; generating and storing two or more copies of the file. Each copy of the file is stored in a storage bucket and a corresponding target. A copy of the file is split among the one or more computing nodes mapped to the storage bucket.

In accordance with the disclosure, another aspect of the present disclosure provides a storage cluster with a composable infrastructure. The storage cluster includes a plurality of storage buckets, a plurality of computing nodes, a plurality of targets remotely connected to the plurality of computing nodes, and a cluster managing platform. Each of plurality of the storage buckets is mapped to one or more of the plurality of computing nodes. Each of the plurality of computing nodes is mapped to one or more storage buckets. The cluster managing platform is configured to obtain a hierarchy map of the storage cluster, where the hierarchy map reflects a mapping between the plurality of storage buckets, the plurality of computing nodes and the plurality of targets. The cluster managing platform is further configured to receive a file to be stored in the storage cluster, determine a mapping of the plurality of targets to the plurality of computing nodes, determine a mapping rule of each of the plurality of storage buckets to one of the plurality of targets by connecting through one or more of the plurality of computing nodes, and generate and store two or more copies of the file, each copy of the file being stored in a storage bucket and a corresponding target. A copy of the file is split among the one or more computing nodes mapped to the storage bucket.

In accordance with the disclosure, further another aspect of the present disclosure provides an electronic device for managing a storage cluster with a composable infrastructure. The electronic device includes one or more processors and a memory coupled to the one or more processors. The memory stores instructions that, when executed by the one or more processors, the one or more processors are caused to receive a file to be stored in the storage cluster. The storage cluster including a plurality storage buckets, a plurality of computing nodes, and a plurality of targets mapped to the plurality of storage buckets though the plurality of computing nodes. The one or more processors are further caused to determine a mapping of the plurality of targets to the plurality of computing nodes, determine a mapping rule of each of the plurality of storage buckets to one of the plurality of targets by connecting through one or more of the plurality of computing nodes, and generate and store two or more copies of the file, each copy of the file being stored in a storage bucket and a corresponding target, wherein a copy of the file is split among the one or more computing nodes mapped to the storage bucket.

The method provided by the present disclosure can optimize management of storage cluster by allowing the cluster managing platform in a composable infrastructure to know the redundancy distribution. Further, by implementing the method according to some embodiments of the present disclosure, the storage cluster, when a failure within the cluster occurs, is able to bring an alternative resource into the cluster to rebuild the storage cluster.

### DESCRIPTION OF THE DRAWINGS

FIG. 1 illustrates an exemplary storage cluster according to an embodiment of the present disclosure.

FIG. 2 illustrates another exemplary storage cluster according to an embodiment of the present disclosure.

FIG. 3 illustrates storing a file in the storage cluster shown in FIG. 2 according to an embodiment of the present disclosure.

FIG. 4 illustrates another exemplary storage cluster including a hierarchy map according to an embodiment of the present disclosure.

FIG. 5 illustrates another exemplary storage cluster including a hierarchy map according to an embodiment of the present disclosure.

FIG. 6 illustrates storing a file in the storage cluster shown in FIG. 5 according to an embodiment of the present disclosure.

FIG. 7 illustrates another exemplary storage cluster including a hierarchy map according to an embodiment of the present disclosure.

FIG. 8 illustrates a flowchart of an exemplary method for managing a storage cluster with a composable infrastructure according to an embodiment of the present disclosure.

FIG. 9 illustrates a flowchart of another exemplary method for managing a storage cluster with a composable infrastructure according to an embodiment of the present disclosure.

FIG. 10 illustrates a cluster managing platform for managing a storage cluster with a composable infrastructure according to an embodiment of the present disclosure.

FIG. 11 illustrates an electronic device or a software for managing a storage cluster with a composable infrastructure according to an embodiment of the present disclosure.

### DETAILED DESCRIPTION

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Example embodiments will be described with reference to the accompanying drawings, in which the same numbers refer to the same or similar elements unless otherwise specified.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

A storage cluster in a cloud computing environment controlled by a software, e.g., Ceph, is widely used for storing data and files. The storage cluster may break a file into a set of data units that are spread across the cluster. The storage cluster may include a plurality of computing nodes for storing the data units of the file.

In a storage cluster that employs a composable infrastructure, computing nodes use shared storage resources for storing a unit of data and multiple replica copies of data are generated based on the data units at the computing nodes, thereby providing redundancy and reliability of data storage. The storage cluster assumes that each bucket for storing one of the replica copies is independent from another, and that each bucket is protected from a single node failure in the storage cluster. However, because in the composable infrastructure, common resources may be assigned to multiple buckets and multiple nodes, a malfunctioning in the composable infrastructure of the cloud platform, such as a failure in one of the shared storage resources, may cause the cloud platform to lose redundancy coverage and therefore cannot reconstruct the data.

The present disclosure provides a method, a cluster managing platform, and a device for managing a storage cluster with a composable infrastructure. The technical solutions provided in the present disclosure enables the storage cluster to be aware of its composition, to include adaptive redundancy domains, and to efficiently assign storage resources for storing data.

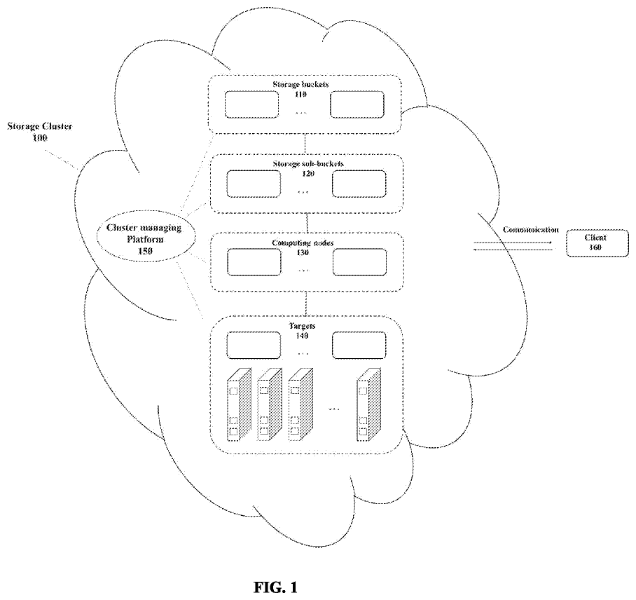

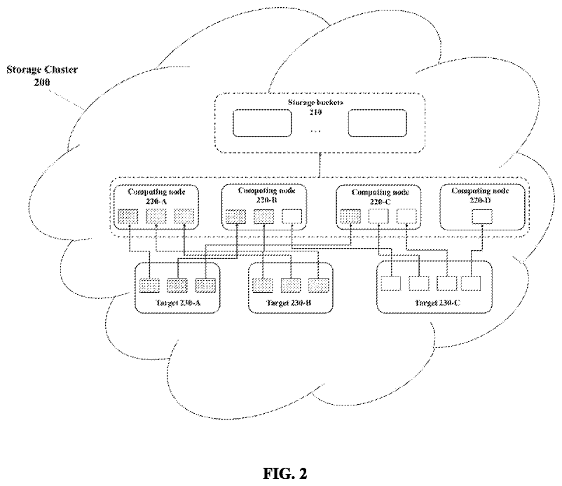

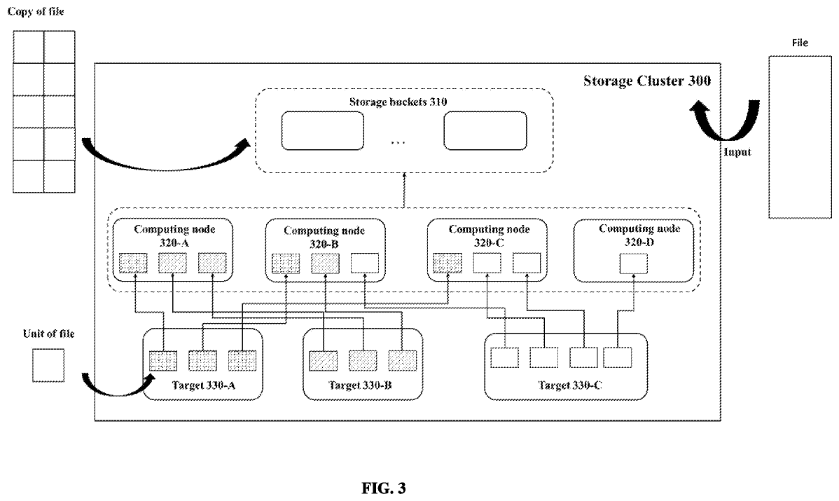

FIGS. 1 and 2 illustrate exemplary storage clusters according to an embodiment of the present disclosure. FIG. 3 illustrates storing a file in the storage cluster shown in FIG. 2 according to an embodiment of the present disclosure. For example, as shown in FIG. 1, the storage cluster 100 may communicate with a client 160, e.g., a mobile terminal, a personal computer, a server, a data center, etc., to receive data and instructions and transmit data. The data received by the storage cluster 100 from the client 160 may include a trained data model by machine learning or deep learning. The trained data model may be completed or still in a training process. The trained data model may be periodically input to the storage cluster 100 for data backup. The data received by the storage cluster 100 from the client 160 may include other type of data, which is not limited by the present disclosure.

In some embodiments, as shown in FIG. 1, the storage cluster 100 includes a plurality of computing nodes 130. After receiving data, e.g., a file, from the client 160, the storage cluster 100 may break the file into a set of data units to spread across the plurality of computing nodes 130 within the storage cluster 100. The storage cluster 100 further includes a plurality of storage buckets 110. Each storage bucket 110 include a plurality of sub-buckets 120. The plurality of sub-buckets 120 each include a plurality of computing nodes 130. Some embodiments of the present disclosure are described in a simplified manner in which the storage buckets are parent nodes of the computing nodes. It is well known to one of ordinary skilled in the art that there may be more than one level of nodes between the storage buckets and the computing nodes, which is not limited by the present disclosure.

In some embodiments, the storage cluster may be a Ceph storage cluster, in which, the Object Storage Daemon (physical or logical OSD) manages a storage unit. The Ceph storage cluster implements controlled replication under scalable hashing (CRUSH) algorithm to define a bucket hierarchy to segregate leaf nodes by their failure domains, such as hosts, racks, rows, rooms, and data centers. A CRUSH map contains a list of “buckets” for OSDs, aggregating the devices into physical locations, and a list of rules for CRUSH to replicate data in a Ceph cluster's pools. In the composed implementation of Ceph over Rack-Scale Design (RSD), RSD targets hold the physical storage resource, and remotely attach themselves as logical drive to RSD initiators to build the Ceph OSD. Referring the FIG. 1, in one example, the storage bucket 110 may be a Ceph bucket. The storage sub-bucket 120 may be an OSD bucket. The computing node 130 may be an RSD initiator. The target 140 may be an RSD target.

Referring to FIG. 1, in some embodiments of the present disclosure, the plurality of computing nodes 130 may be a plurality of servers that are connected to a plurality of targets 140. A target 140 may be one or more physical storage devices that are hold by physical hardware or one or more servers and mapped to one or more computing nodes 130. The data units assigned to the computing nodes 130 may be stored in the targets 140. Each target 140 may include one or more memories. A number of memories that are include in each target 140 may be the same or different among the plurality of targets140. In some embodiments, at least one of the memories of the targets 140 may be non-volatile memory express (NVMe) drive that is remotely connected to the computing nodes 130. The NVMe drive refers to NVMe based solid state drive (SSD), which is a peripheral component interconnect express (PCIe) connected SSD using NVMe. A target 140 may include multiple NVMe drives installed in the PCIe slot of the target 140. The targets 140 may include other types of memories, e.g., removable storage devices, read-only memory (ROM), magnetic disks, compact discs, or other media that can store data.

In some embodiments, there may be little data storage in the computing nodes 130. Data storage is mostly located in the memories of the targets 140 that are remotely connected and mapped to the computing nodes 130. The storage sub-buckets 120 themselves may not be aware that there is a mapping between the computing nodes 130 and memories of the targets 140. The storage sub-buckets 120 may have the view that the computing nodes 130 are connected to the targets 140 directly and communicate with the memories of the targets 140 directly.

In some embodiments, the plurality of targets 140 may be remotely connected to the plurality of computing nodes 130 via a network, e.g., Ethernet or any suitable network. The computing nodes 130 serving as drives with the processors of drives separated from the memories that are included in the targets 140. In such implementations, a drive can be shared multiple times across multiple processors and memory complexes, thereby achieving another degree of flexibility.

For example, as shown in FIG. 2, the storage cluster 200 may include a plurality of storage buckets 210, computing nodes 220-A, 220-B, 220-C, and 220-D. Computing node 220-A is connected to target 230-A and 230-B, computing node 220-B is connected to target 230-A, 230-B, and 230-C, computing node 220-C is connected to target 230-A and 230-C, and computing node 220-D is connected to target 230-C.

In some embodiments, as shown in FIG. 3, when the storage cluster 300 receives a file to be stored, the storage cluster 300 may divide the file into a set of data units and distribute the data units to computing nodes 320 for storage. The data units of the file are stored in the targets that are remotely connected to the computing nodes 320 and mapped to the computing nodes 320.

In some embodiments, to provided redundancy, the storage cluster may create multiple replica copies of the data file, breaks each replica copy of the file into a set of data units, and distributes the data units of the file to computing nodes for storage. The data units of the file are stored in the targets that are remotely connected to the computing nodes and mapped to the computing nodes. Replica copies of the file are stored in different storage buckets. The storage buckets that are not aware of its composition may group the computing nodes in a random manner. In some embodiments, a storage bucket may be mapped to multiple computing nodes and a computing node may be mapped to multiple targets. As such, a failure of a target may affect the multiple storage buckets that are mapped to the failed target, causing the storage cluster to lose more than one degree of redundancy coverage, or even completely lose redundancy coverage.

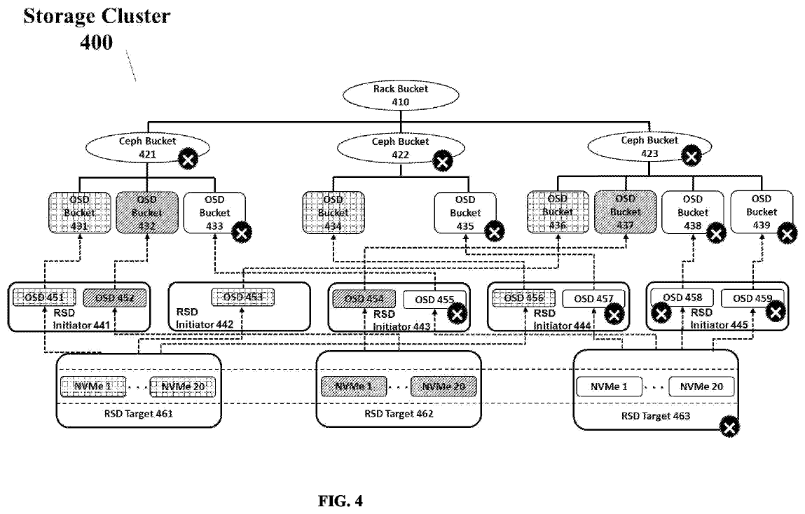

FIG. 4 illustrated a hierarchy map of an exemplary storage cluster 400, e.g., a Ceph storage cluster, according to some embodiments of the present disclosure. The hierarchy map of the storage cluster 400 reflects mapping of Ceph buckets 421-423, OSD buckets 431-439, RSD initiators 441-445, and RSD target 461-463. The Ceph buckets 421-423 are parent nodes to OSD buckets 431-439 that correspond to OSDs 451-459 of RSD initiators 441-445. The RSD targets 461-463 are attached to the RSD initiators 441-445. In the storage cluster 400, each Ceph bucket is mapped to multiple RSD targets. In such an implementation, a failure in one of the RSD targets, may cause failure of multiple Ceph buckets. For example, malfunction of RSD target 463 causes failure of the OSDs that are mapped to the RSD targets 463, i.e., OSD 455 of RSD initiator 443, OSD 457 of RSD initiator 444, OSDs 458 and 459 of RSD initiator 445. Further, OSD buckets 433, 435, 438, and 439 that are mapped to the above failed OSDs will also fail, which leads to failure of all the three Ceph buckets 421-423 that are mapped to the failed OSD buckets. Referring to FIGS. 3 and 4, when the RSD target 463 fails, the storage cluster 400 loses the replica copies of the file stored in all three Ceph buckets 421-423, i.e., the storage cluster 400 loses redundancy coverage completely and has no capability of recovering.

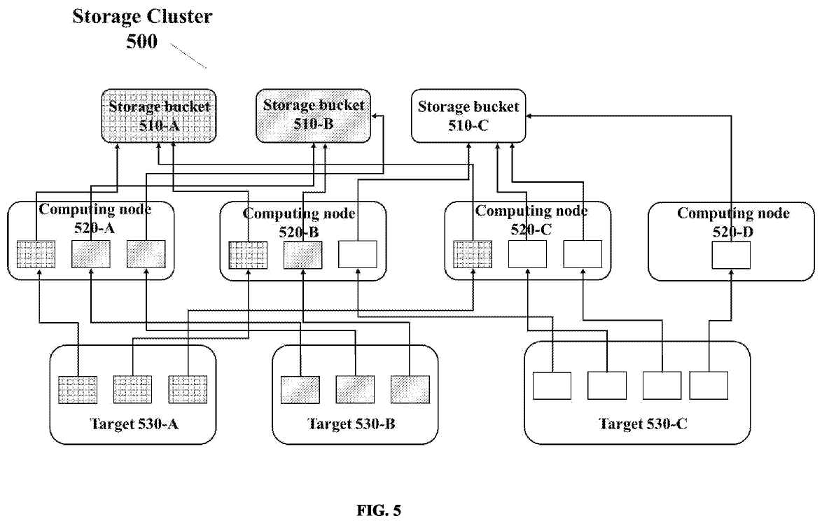

FIG. 5 illustrates another exemplary storage cluster 500 including a hierarchy map according to an embodiment of the present disclosure. The storage cluster 500 includes a plurality of computing nodes 520 with a plurality of targets 530 attached to the computing nodes 520. The computing nodes 520 correspond to a plurality of storage buckets 510 and each storage bucket 510 is mapped to one of the plurality of targets 530. In some embodiments, a number of the storage buckets 510 may be the same as a number of the targets 530. The storage buckets 510 may be mapped one-to-one with the targets 530. For example, as shown in FIG. 4, the storage cluster 500 includes computing node 520-A, 520-B, 520-C, and 520-D. Computing node 520-A is connected to target 530-A and 530-B, computing node 520-B is connected to target 530-A, 530-B, and 530-C, computing node 520-C is connected to target 530-A and 530-C, and computing node 520-D is only connected to target 530-C. The storage bucket 510-A is mapped to target 530-A, the storage bucket 510-B is mapped to target 530-B, and the storage bucket 510-C is mapped to target 530-C.

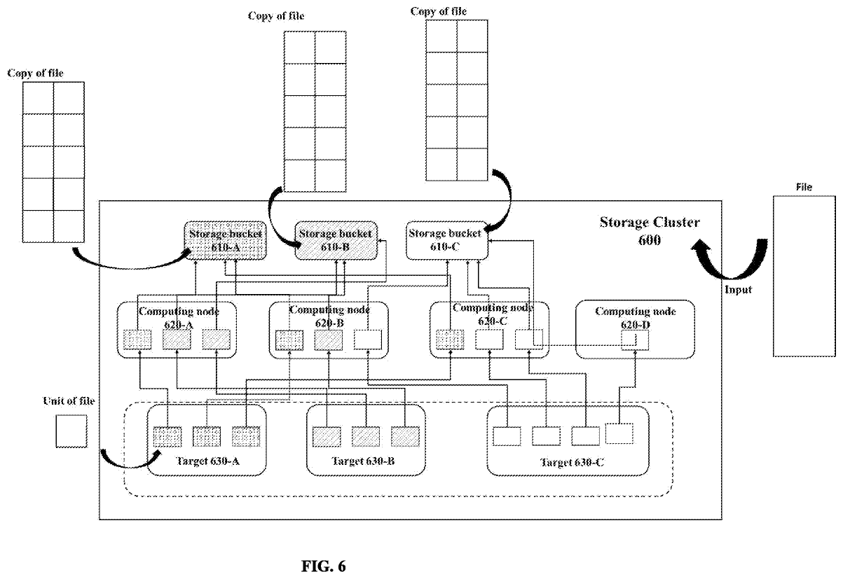

FIG. 6 illustrates the process of storing a file in the storage cluster shown in FIG. 5 according to an embodiment of the present disclosure. When the storage cluster 600 receives a file to be stored or before the storage cluster 600 receives the file, the storage cluster 600 may call computing nodes 620s to know the corresponding target 630 of the attached drive corresponding to each of the computing nodes 620. For example, the storage cluster 600 may call the computing nodes to send a message to targets 630s, and in response, one or more targets 630s that receives the message may each send a response message to the computing nodes 620s. The response message may contain information that can identify the target 630s. For example, the information may include a physical address, a device ID, etc. of a corresponding one of the targets 630s. Based on the response message sent from the one or more targets 630s, the storage cluster 600 may obtain a hierarchy map of the storage cluster 600. The hierarchy map includes mapping relationships between the storage buckets 610s and the computing nodes 620s, and mapping relationships between the computing nodes 620 and the targets 630. The storage cluster 600 may obtain and update the hierarchy map in different manners. For example, the storage cluster 600 may call all the computing nodes 620s to obtain the hierarchy map in response to receiving a file to be stored. In another example, the storage cluster 600 may call all the computing nodes 620s to obtain the hierarchy map for every preset time interval. The preset time interval may be one or more seconds, minutes, hours, days, etc. In further another example, the storage cluster 600 may call all the computing nodes 620s for every preset time interval and also in response to receiving a file to be stored, to obtain the hierarchy map. As such, the hierarchy map may be updated dynamically, and a malfunctioning target 630 may be excluded from storing the data units.

Further storage cluster 600 may create multiple replica copies of the file, breaks each replica copy of the file into a set of data units, and distributed the data units to computing nodes 620s for storage based on the hierarchy map. The data units of the file are stored in the targets 630s that are remotely connected to the computing nodes 620s and mapped to the computing nodes 630s. Each replica copy of the file may be stored in one storage bucket 610. Each storage bucket 610 corresponds to a number of computing nodes 620s. One of the plurality of computing nodes 620s may be connected to multiple targets 630s, and one target 630 may be connected to multiple computing nodes 620s. In FIG. 6, The storage buckets 610s are of one-to-one correspondence with the targets 630s. Accordingly, a malfunctioning target 630 may result in a loss of storage bucket 610 that corresponds to the malfunctioning target 630 without affecting the other storage buckets 610s, and the storage cluster 600 can still have a degraded redundancy coverage and is capable to recover to a full redundancy coverage.

For example, as shown in FIG. 6, when the storage cluster receives a file to be stored, the storage cluster 600 may create three replica copies of the file, breaks each replica copy of the file into a set of data units, and distributed the data units to four computing nodes 620-A, 620-B, 620-C, and 620-D for storage based on the hierarchy map of the storage cluster 600. For example, the data units of the file are stored in the targets 630-A, 630-B. and 630-C that are remotely connected to and mapped to the computing nodes 620-A, 620-B, 620-C, and 620-D.

The replica copies are stored in the storage buckets 610-A, 610-B, and 610-C that include the computing nodes 620-A, 620-B, 620-C, and 620-D. Computing node 620-A is connected to target 630-A and 630-B, computing node 620-B is connected to target 630-A, 630-B, and 630-C, computing node 620-C is connected to target 630-A and 630-C, and computing node 620-D is only connected to target 630-C. The storage bucket 610-A is mapped to target 630-A, the storage bucket 610-B is mapped to target 630-B, and the storage bucket 610-C is mapped to target 630-C. The storage bucket 610-A is mapped to the target 630-A, the storage bucket 610-B is mapped to the target 630-B, and the storage bucket 610-C is mapped to the target 630-C.

The replica copy corresponding to the storage bucket 610-A include data units of the file that are stored in memories of the target 630-A. The replica copy corresponding to the storage bucket 610-B is generated by aggregating data units of the file that are stored in memories of the target 630-B. The replica copy corresponding to the storage bucket 610-C is generated by aggregating data units of the file that are stored in memories of the target 630-C.

In a scenario that one of the targets 630 fails, multiple computing nodes 620 may be affected, but only one storage bucket 610 that corresponds to the failed target 630 is affected. For example, when the target 630-A fails, multiple computing nodes 620-A, 620-B, and 620-C are affected, but only the storage bucket 610-A that corresponds to the target 630-A is affected. The storage cluster 600 have a degraded redundancy coverage from three replica copies to two replica copies corresponding to storage buckets 610-B and 610-C. The storage cluster 600 can rebuild a new replica copy using the remaining two replica copies to recover to a full redundancy coverage, thereby improving reliability of the storage cluster 600.

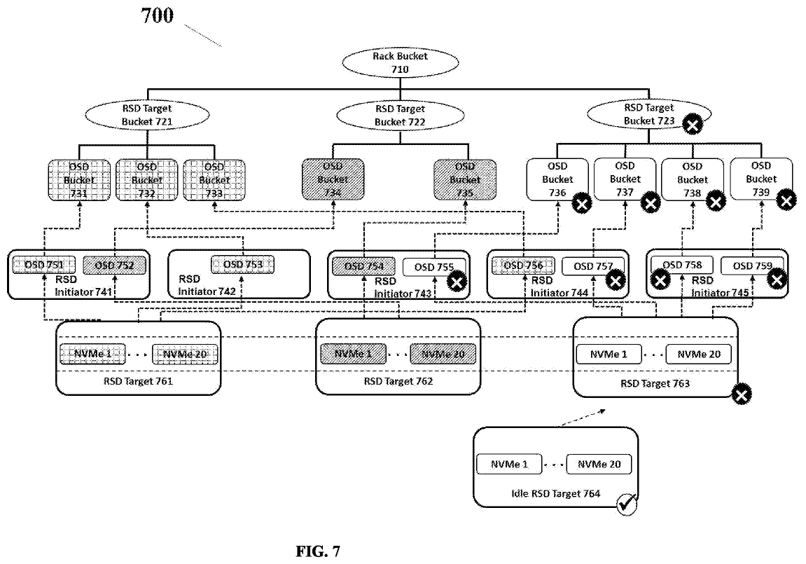

FIG. 7 illustrated a hierarchy map of an exemplary storage cluster 700, e.g., Ceph, according to some embodiments of the present disclosure. The hierarchy map of the storage cluster 700 reflects mapping of RSD target buckets 721-723, OSD buckets 731-739, RSD initiators 741-745, and RSD target 761-763. The RSD target buckets 721-723 are parent nodes to OSD buckets 731-739 that aggregate OSDs 751-759 of RSD initiators 741-745. The RSD targets 761-763 are attached to the RSD initiators 741-745. In the storage cluster 700, each Ceph bucket is mapped one to one with each of the RSD targets. In such an implementation, a failure in one of the RSD targets may cause failure of multiple OSD buckets and multiple RSD initiators, but may affect only one RSD target bucket that is mapped to the failed RSD target. For example, malfunction of 763 causes failure of the OSDs that are mapped to the RSD targets 763, i.e., OSD 755 of RSD initiator 743, OSD 757 of RSD initiator 744, OSDs 758 and 759 of RSD initiator 745. Further, OSD buckets 736, 737, 738, and 739 that are mapped to the above failed OSDs also fail, which leads to failure of only one RSD target buckets 723 that are mapped to the failed OSD buckets. Referring to FIGS. 6 and 7, when the RSD target 763 fails, the storage cluster 400 loses only one RSD target bucket 723 and the one copy of the file stored therein. The storage cluster 700 have a degraded redundancy coverage from three replica copies to two replica copies corresponding to storage buckets 721 and 722. The storage cluster 700 can rebuild a new replica copy using the remaining two replica copies to recover to a full redundancy coverage, thereby improving reliability of the storage cluster 700.

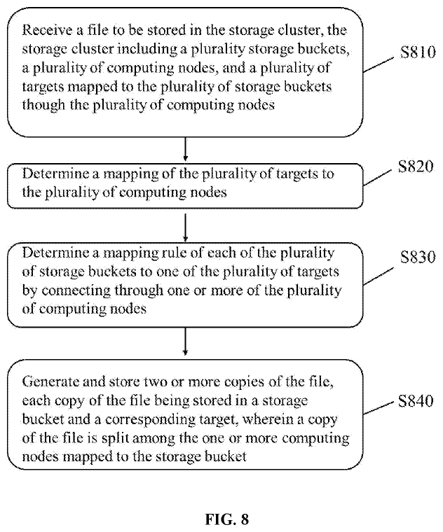

FIG. 8 illustrates a flowchart of an exemplary method for managing a storage cluster with a composable infrastructure according to an embodiment of the present disclosure. In some embodiments of the present disclosure, the method includes receiving a file to be stored in the storage cluster at S810, where the storage cluster includes a plurality storage buckets, a plurality of computing nodes, and a plurality of targets mapped to the plurality of storage buckets though the plurality of computing nodes.

The method further includes determining a mapping of the plurality of targets to the plurality of computing nodes at S820. The storage cluster may call the plurality of computing nodes to know the corresponding one or more targets attached. Based on the mapping between the plurality of targets to the plurality of computing nodes, a storage cluster may generate a hierarchy map of itself. The hierarchy map reflects a mapping between the plurality of storage buckets, the plurality of computing nodes, and the plurality of targets.

The method further includes determining a mapping rule of each of the plurality of storage buckets to one of the plurality of targets by connecting through one or more of the plurality of computing nodes at S830. The hierarchy map may be modified based on the mapping rule, and in the modified hierarchy map, each of the plurality of storage buckets is mapped to one of the plurality of targets by connecting through one or more of the plurality of computing nodes.

The method further includes generating and storing two or more copies of the file at S840, where each copy of the file is stored in a storage bucket and a corresponding target. A copy of the file is split among the one or more computing nodes mapped to the storage bucket. The storage cluster may break the file into a set of units, and distributes the units of the file to the plurality of computing nodes for storage. For example, two or more copies of file may be three copies, and the three copies of file correspond to three different storage buckets, respectively, and are stored in three different targets, respectively. The three different storage buckets are of one-to-one correspondence relationship with the three different targets.

Consistent with above embodiments of the storage cluster, the storage cluster is configured to receive a file and store the file by breaking the file into units of the file and distributing the units of the file to a plurality of computing nodes within the storage cluster. A plurality of targets are remotely connected to the computing nodes. As shown in FIG. 1, the storage cluster may include a cluster managing platform. The cluster managing platform may be configured to obtain the hierarchy map of the storage cluster. The cluster managing platform may be a controller including one or more processors and memories for storing instructions that can be executed by the one or more processers. In some other embodiments, the cluster managing platform may be a software or an application installed in an electronic device.

In some embodiments, the targets may be rearranged and remapped to the computing nodes. One or more new targets may be mapped to the computing nodes. One or more targets may be disconnected from the computing nodes. In a scenario that one of the targets fails, the failed target may be disconnected from the computing nodes. A recovered target or an idle target may be reconnected to the computing nodes with a same mapping structure or a different mapping structure. The hierarchy map may be updated in response to a change of connections within the storage cluster. The cluster managing platform may generate a request to obtain an updated hierarchy map in response to detecting a change of connections within the storage cluster. The cluster managing platform may define a number of storage buckets according to a number of targets. Based on the hierarchy map, the cluster managing platform of the storage cluster aware of how the storage cluster is assigning storage buckets, such that accidentally putting all of the storage connections into only one target can be avoided, thereby avoiding a scenario that a failure of the target causes the storage cluster to completely lose redundancy coverage.

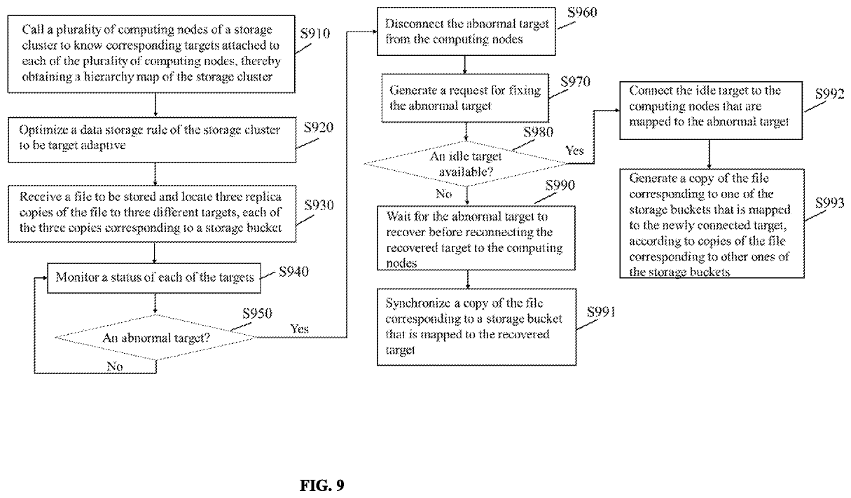

FIG. 9 illustrates a flowchart of another exemplary method for managing a storage cluster with a composable infrastructure according to an embodiment of the present disclosure.

In some embodiments of the present disclosure, the method includes calling a plurality of computing nodes of a storage cluster to know corresponding targets attached to each of the plurality of computing nodes, thereby obtaining a hierarchy map of the storage cluster at S910. The storage cluster includes a plurality storage buckets, the plurality of computing nodes, and a plurality of targets, and the hierarchy map reflects a mapping between the plurality of storage buckets, the plurality of computing nodes, and the plurality of targets.

The cluster managing platform optimizes a data storage rule of the storage cluster to be target adaptive at S920. For example, in a target adaptive storage cluster, a storage bucket groups all data units of a copy of a file to be stored, and all the data units of the copy of the file to be stored are stored in a target that is mapped to the storge bucket.

The method further includes receiving a file to be stored and locating three replica copies of the file to three different targets, each of the three copies corresponding to a storage bucket at S930. Each of the three different storage buckets is mapped one-to-one with each of the three different targets by connecting through one or more computing nodes mapped to the three different storage buckets. A number of the replica copies of the file may be two, three, or more than three, which is not limited herein.

In some embodiments, the method further includes monitoring a status of each of the targets at S940. For example, the cluster managing platform may monitor a status of the whole storage cluster, including a status of each computer nodes and a status of each of the targets that remotely connected to the computer nodes. The cluster managing platform may perform the monitoring in a real-time manner. The cluster managing platform may perform the monitoring in another preset manner, e.g., performing monitoring in a preset time interval. The preset interval may be set in seconds, minutes, or hours, which is not limited by the present disclosure.

The cluster managing platform may determine whether there is an abnormal target based on the status of each of the targets at S950. In some embodiments, the targets may send status information of the targets to the cluster managing platform and the cluster managing platform may monitor the status of each of the targets according to the status information of the targets.

The status information of the targets may be obtained by one or more sensors coupled to the targets or one or more sensors included in the targets. In some embodiments, the targets may determine whether a failed target, i.e., an abnormal target, is detected and send a report to the cluster managing platform. The cluster managing platform may determine there is an abnormal target upon receiving the report.

In some other embodiments, the cluster managing platform may directly receive sensor data collected by one or mor sensors that care coupled to the computing nodes or the targets and monitor the status of each of the targets based on the sensor data, so as to determine where the targets include an abnormal target.

In some other embodiments, the cluster managing platform may send a message to each of the targets through the computing nodes. The cluster managing platform may determine that a target is in an abnormal status if the target does not respond to the message, if the cluster managing platform determines that sending the message fails, or if the target sends a response message indicating the target is in the abnormal status.

The abnormal target may include a target having hardware failure, a target having software failure, or a target having poor connection to the mapped computing nodes.

In response to determining the targets includes an abnormal target, the abnormal target is disconnected from the computing nodes at S960, and the cluster managing platform generates a request for fixing the abnormal target S970. In some embodiments, once the abnormal target is recovered, the recovered targets may send a message to inform the cluster managing platform about its status is changed from abnormal to normal.

In response to determining the targets includes an abnormal target, the cluster managing platform may further determine whether an idle target is available at S980. The idle target may include a well-functioning target that is not occupied for data storage. The idle target may include a newly added target that has not been assigned for data storage. The idle target may include a recovered target that has not been assigned for data storage.

In response to determining that no idle target is available, the cluster managing platform may wait for the abnormal target to recover and then reconnect the recovered target to the mapped computing nodes at S990. The storage cluster may be degraded by losing one degree of redundancy coverage. In this scenario, there is a time interval between a first time point where the abnormal target is detected and disconnected from the computing nodes and a second time point where the recovered target is reconnected to the computing nodes. Thus, a replica copy corresponding to the storage bucket that is mapped to the abnormal target at the first time point may be different from the replica copies corresponding to the other storage buckets at the second time point. To recover the storage cluster to a full redundancy coverage, the replica copy corresponding to the storage bucket that is mapped to the recovered target may be synchronized with replica copies of the file corresponding to the other storage buckets at S991.

In response to determining there is an idle target available, the cluster managing platform may further connect the idle target to the computing nodes that are previously mapped to the abnormal target at S992. To recover the storage cluster to a full redundancy coverage, the cluster managing platform may generate a replica copy corresponding to the storage bucket that is mapped to the newly connected target according to replica copies of the file corresponding to the other storage buckets at S993.

For example, referring to FIG. 7, when the cluster managing platform determines that the RSD target 763 fails, multiple RSD initiators 743-745 are affected, but only the RSD target bucket 723 that corresponds to the target 763 is affected. The storage cluster 700 have a degraded redundancy coverage from three replica copies to two replica copies corresponding RSD target buckets 721 and 722. Upon determining that the RSD target 763 fails, the cluster managing platform may disconnect the RSD target 763 from RSD initiators 743-745 and generate a request for fixing the RSD target 763.

If the cluster managing platform determines that there is no idle target available, the cluster managing platform may wait for a recovery of the RSD target 763 and reconnect the recovered RSD target 763 to the RSD initiators 743-745. The cluster managing platform may synchronize a replica copy of the file corresponding to the RSD target bucket 723 that is mapped to the RSD target 763 with replica copies of the file corresponding to the RSD target buckets 721 and 722, and the redundancy coverage of the storage cluster 700 can thus be recovered to three replica copies again.

If the cluster managing platform determines that there is an idle target available, the cluster managing platform may connect the idle RSD target 764 to the computing nodes 743-745. The cluster managing platform may generate a replica copy of the file corresponding to the RSD target bucket 723 that is mapped to the newly connected RSD target 764 with replica copies of the file corresponding to the RSD target buckets 721 and 722 and the redundancy coverage of the storage cluster can thus be recovered to three replica copies again.

The method consistent with the embodiments of the present disclosure may also be implemented in an electronic device. The electronic device may be a computing device or a group of computing devices. The electronic device may a computer or a server. The electronic device may be connected to the computing nodes within the storage cluster and targets (e.g., physical storage devices) that are remotely connected to the computing nodes.

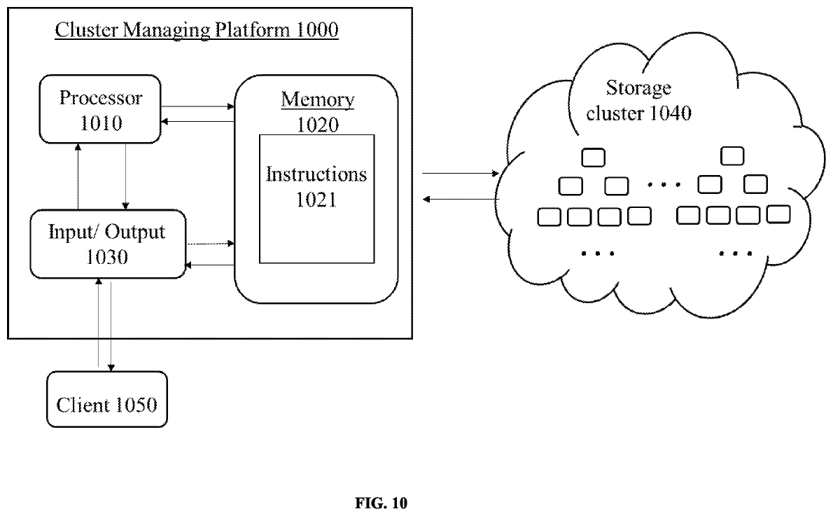

FIG. 10 illustrates a cluster managing platform 1000 for managing a storage cluster with a composable infrastructure according to an embodiment of the present disclosure. As shown in FIG. 10, the cluster managing platform 1000 includes a processor 1010 and a memory 1020 coupled to the processor 1010. The memory 1020 may store instructions 1022 that, when executed by the processor 1010, cause the processor 1010 to perform the method consistent with the above embodiments of the present disclosure. The cluster managing platform 1000 may further include an input/output interface 1030 coupled to the processor 1010 and the memory 1020. Via the input/output interface 830, the cluster managing platform 1000 may receive and transmit data and/or instructions to a client, e.g., a mobile terminal, a personal computer, a server, a data center, etc.

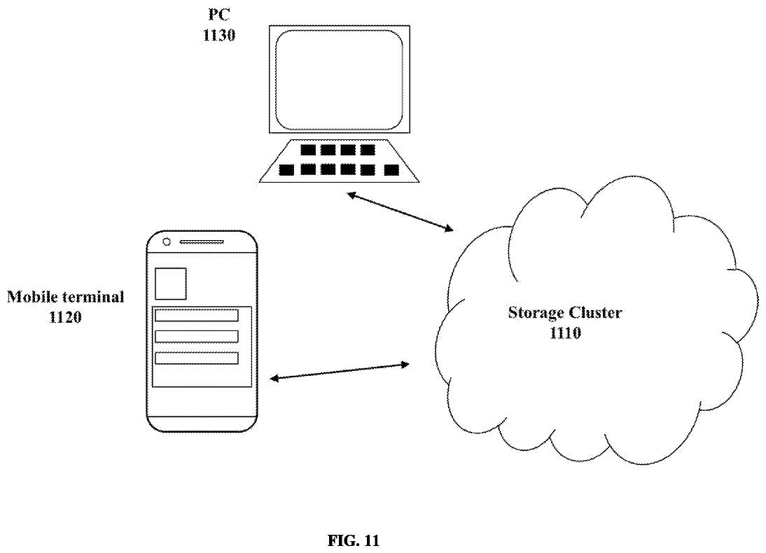

As shown in FIG. 11, the cluster managing platform may be a controller for controlling the fabric nodes of the storage cluster 1110. The cluster managing platform may be a software that includes algorithm for implementing the method consistent with embodiments of the present disclosure. The cluster managing platform may be a software or an application installed in a computing device, e.g., a personal computer (PC) PC 1130, a mobile terminal 1120, or a server.

The method, cluster managing platform, and storage cluster provided by the present disclosure can optimize management of storage cluster by allowing the cluster managing platform in a composable infrastructure to aware its composition and the redundancy distribution. Further, by implementing the method according to some embodiments of the present disclosure, the storage cluster, when a failure within the cluster occurs, is able to bring an alternative resource into the cluster to rebuild the storage cluster.

For simplification purposes, detailed descriptions of the operations of apparatus, device, and units may be omitted, and references can be made to the descriptions of the methods.

The disclosed apparatuses, device, and methods may be implemented in other manners not described here. For example, the devices described above are merely illustrative. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above.

The storage medium can be any medium that can store program codes, for example, a USB disk, a mobile hard disk, a read-only memory (ROM), a random-access memory (RAM), a magnetic disk, or an optical disk.

Other embodiments of the disclosure will be apparent to those skilled in the art from consideration of the specification and practice of the embodiments disclosed herein. It is intended that the specification and embodiments be considered as examples only and not to limit the scope of the disclosure. Any modification and equivalently replacement for the technical solution of the present disclosure should all fall in the spirit and scope of the technical solution of the present disclosure.

What is claimed is:

1. A method for managing a storage cluster with a composable infrastructure, comprising:
receiving a file to be stored in the storage cluster, the storage cluster including a plurality storage buckets, a plurality of computing nodes, and a plurality of targets mapped to the plurality of storage buckets though the plurality of computing nodes;
determining a mapping of the plurality of targets to the plurality of computing nodes;
determining a mapping rule of each of the plurality of storage buckets to one of the plurality of targets by connecting through one or more of the plurality of computing nodes;
generating and storing two or more copies of the file, each copy of the file being stored in a storage bucket and a corresponding target, wherein a copy of the file is split among the one or more computing nodes mapped to the storage bucket.

2. The method according to claim 1, further comprising:
monitoring a status of each of the plurality of targets to determine whether the plurality of targets include an abnormal target;
disconnecting, in response to determining that the plurality of targets include the abnormal target, the abnormal target from the plurality of computing nodes; and
generating a request for fixing the abnormal target.

3. The method according to claim 2, further comprising:
determining, in response to determining that the plurality of targets include the abnormal target, whether an idle target is available.

4. The method according to claim 3, further comprising:
waiting for the abnormal target to recover before reconnecting the recovered target to the plurality of computing nodes, in response to no idle target being available; and
synchronizing a copy of the file corresponding to a storage bucket that is mapped to the recovered target.

5. The method according to claim 3, further comprising:
connecting, in response to the idle target being available, the idle target to computing nodes that are mapped to the abnormal target; and
generating a copy of the file corresponding to one of the plurality of storage buckets that is mapped to the newly connected target, according to copies of the file corresponding to other ones of the plurality of storage buckets.

6. The method according to claim 2, further comprising:
receiving, from the plurality of targets, status information of the plurality of targets; and
monitoring the status of each of the plurality of targets according to the status information.

7. The method according to claim 1, wherein:
at least one of the plurality of targets includes a plurality of physical storage devices; and
the plurality of storage devices includes a first storage device remotely attached to one of the plurality of computing nodes and a second storage device remotely attached to another one of the plurality of computing nodes.

8. The method according to claim 1, wherein:
the storage cluster further includes a plurality of sub storage buckets connected between the plurality of storage buckets and the plurality of computing nodes.

9. The method according to claim 1, wherein:
a copy of the file corresponding to a storage bucket is composed of portions of the file stored in a target mapped to computing nodes that are aggregated by the storage bucket.

10. A storage cluster with a composable infrastructure, comprising:
a plurality of storage buckets;
a plurality of computing nodes, each of plurality of the storage buckets being mapped to one or more of the plurality of computing nodes, each of the plurality of computing nodes being mapped to one or more storage buckets;
a plurality of targets remotely connected to the plurality of computing nodes; and
a cluster managing platform configured to:
receive a file to be stored in the storage cluster;
determine a mapping of the plurality of targets to the plurality of computing nodes;
determine a mapping rule of each of the plurality of storage buckets to one of the plurality of targets by connecting through one or more of the plurality of computing nodes; and
generate and store two or more copies of the file, each copy of the file being stored in a storage bucket and a corresponding target, wherein a copy of the file is split among the one or more computing nodes mapped to the storage bucket.

11. The storage cluster according to claim 10, wherein the cluster managing platform is further configured to:
monitor a status of each of the plurality of targets to determine whether the plurality of targets include an abnormal target;
disconnect, in response to determining that the plurality of targets include the abnormal target, the abnormal target from the plurality of computing nodes; and
generate a request for fixing the abnormal target.

12. The storage cluster according to claim 11, wherein the cluster managing platform is further configured to:
determine, in response to determining that the plurality of targets include the abnormal target, whether an idle target is available.

13. The storage cluster according to claim 12, wherein the cluster managing platform is further configured to:
wait for the abnormal target to recover before reconnecting the recovered target to the plurality of computing nodes, in response to no idle target being available; and
synchronize a copy of the file that is corresponding to a storage bucket that is mapped to the recovered target.

14. The storage cluster according to claim 12, wherein the cluster managing platform is further configured to:
connect, in response to the idle target being available, the idle target to computing nodes that are mapped to the abnormal target; and
generate a copy of the file corresponding to one of the plurality of storage buckets that is mapped to the newly connected target, according to copies of the file corresponding to other ones of the plurality of storage buckets.

15. The storage cluster according to claim 10, wherein the cluster managing platform is further configured to:
receive, from the plurality of targets, status information of the plurality of targets; and
monitor the status of each of the plurality of targets according to the status information.

16. The storage cluster according to claim 10, wherein:
at least one of the plurality of targets includes a plurality of physical storage devices; and
the plurality of storage devices includes a first storage device remotely attached to one of the plurality of computing nodes and a second storage device remotely attached to another one of the plurality of computing nodes.

17. The storage cluster according to claim 10, wherein the cluster managing platform is further includes a plurality of sub storage buckets connected between the plurality of storage buckets and the plurality of computing nodes.

18. The storage cluster according to claim 10, wherein:
a copy of the file corresponding to a storage buckets is composed of units of the file stored in a target mapped to computing nodes that are aggregated by the storage bucket.

19. An electronic device for managing a storage cluster with a composable infrastructure, comprising
one or more processors; and
a memory coupled to the one or more processors and configured to store instructions that, when executed by the one or more processors, cause the one or more processors to:
receive a file to be stored in the storage cluster, the storage cluster including a plurality storage buckets, a plurality of computing nodes, and a plurality of targets mapped to the plurality of storage buckets though the plurality of computing nodes;
determine a mapping of the plurality of targets to the plurality of computing nodes;
determine a mapping rule of each of the plurality of storage buckets to one of the plurality of targets by connecting through one or more of the plurality of computing nodes;
generate and store two or more copies of the file, each copy of the file being stored in a storage bucket and a corresponding target, wherein a copy of the file is split among the one or more computing nodes mapped to the storage bucket.

20. The electronic device according claim 19, wherein the instructions, when executed by the one or mor processors, further cause the one or more processors are to:
monitor a status of each of the plurality of targets to determine whether the plurality of targets include an abnormal target;
disconnect, in response to determining that the plurality of targets include the abnormal target, the abnormal target from the computing nodes;
in response to no idle target being available,
wait for the abnormal target to recover before reconnecting the recovered target to the plurality of computing nodes; and
synchronize a copy of the file corresponding to a storage bucket that is mapped to the recovered target; and
in response to an idle target being available,
connect the idle target to computing nodes that are connected to the abnormal target; and
generate a copy of the file corresponding to one of the plurality of storage buckets that is mapped to the newly connected target, according to replica copies of the file corresponding to other ones of the plurality of storage buckets.
